(19) United States
(12) Patent Application Publication
(10) Pub. No.: US 2025/0063081 A1
(43) Pub. Date: Feb. 20, 2025

(54) METHOD, APPARATUS, COMPUTER DEVICE, AND STORAGE MEDIUM FOR LINKAGE PARAMETER CONFIGURATION

(71) Applicant: Beijing Zitiao Network Technology Co., Ltd., Beijing (CN)

(72) Inventor: Donghui ZHANG, Beijing (CN)

(21) Appl. No.: 18/807,830

(22) Filed: Aug. 16, 2024

(30) Foreign Application Priority Data
Aug. 17, 2023 (CN) 202311040922.0

(51) Int. Cl. H04L 67/02; H04L 67/10

(52) U.S. Cl. CPC H04L 67/02; H04L 67/10

(57) ABSTRACT

The present disclosure relates to the technical field of computers, and discloses a method, apparatus, a computer device, and a storage medium for linkage parameter configuration. The method provided by the present disclosure includes: obtaining a target linkage parameter, wherein the target linkage parameter includes a first linkage parameter that a local device expects a target content distribution network to execute and/or a second linkage parameter that the target content distribution network expects the local device to execute; writing the target linkage parameter into header information of a hypertext transfer protocol request to obtain a target hypertext transfer protocol request; and transmitting the target hypertext transfer protocol request to the target content distribution network to cause the target content distribution network to generate a first execution policy based on the target linkage parameter.

### CROSS-REFERENCE TO RELATED APPLICATION(S)

This application claims priority to Chinese Application No. 202311040922.0 filed on Aug. 17, 2023, the disclosure of which is incorporated herein by reference in its entity.

### FIELD

The present disclosure relates to the technical field of computers, and in particular, to a method, apparatus, a computer device, and a storage medium for linkage parameter configuration.

### BACKGROUND

In some application scenarios, endpoint-cloud linkage may be involved. For example, to ensure the performance of live streaming on a link between an edge node of a Content Delivery Network (CDN) on a server and a player of a terminal, strong cooperation for optimization between the player of the terminal and the edge node of the CDN is required. An optimization decision can approach the optimal solution by combining state information of the player of the terminal and the edge node of the CDN. Therefore, there is a need for a mechanism for linkage between the player of the terminal and the edge node of the CDN. The most important function of the linkage mechanism is configuration of linkage parameters.

### SUMMARY

In view of this, the present disclosure provides a method, apparatus, a computer device, and a storage medium for linkage parameter configuration.

In a first aspect, the present disclosure provides a method for linkage parameter configuration. The method includes:
obtaining a target linkage parameter, wherein the target linkage parameter includes a first linkage that a local device expects a target content distribution network to execute and/or a second linkage parameter that the target content distribution network expects the local device to execute;
writing the target linkage parameter into header information of a hypertext transfer protocol request to obtain a target hypertext transfer protocol request; and
transmitting the target hypertext transfer protocol request to the target content distribution network to cause the target content distribution network to generate a first execution policy based on the target linkage parameter.

In a second aspect, the present disclosure provides a method for linkage parameter configuration. The method includes:
receiving a target hypertext transfer protocol request, wherein header information of the target hypertext transfer protocol request includes a target linkage parameter, and the target linkage parameter includes a first linkage parameter that a client expects a local device to execute and/or a second linkage parameter that the local device expects the client to execute;
parsing the target hypertext transfer protocol request to obtain the target linkage parameter; and
generating a first execution policy based on the target linkage parameter.

In a third aspect, the present disclosure provides an apparatus for linkage parameter configuration. The apparatus includes:
a target linkage parameter obtaining module, configured to obtain a target linkage parameter, wherein the target linkage parameter includes a first linkage parameter that a local device expects a target content distribution network to execute and/or a second linkage parameter that the target content distribution network expects the local device to execute;
a target linkage parameter writing module, configured to write the target linkage parameter into header information of a hypertext transfer protocol request to obtain a target hypertext transfer protocol request; and
a target hypertext transfer protocol request transmitting module, configured to transmitthe target hypertext transfer protocol request to the target content distribution network to cause the target content distribution network to generate a first execution policy based on the target linkage parameter.

In a fourth aspect, the present disclosure provides a linkage parameter configuration apparatus. The apparatus includes:
a target hypertext transfer protocol request receiving module, configured to receive a target hypertext transfer protocol request, wherein header information of the target hypertext transfer protocol request includes a target linkage parameter, and the target linkage parameter includes a first linkage parameter that a client expects a local device to execute and/or a second linkage parameter that the local device expects the client to execute;
a target hypertext transfer protocol request parse module, configured to parse the target hypertext transfer protocol request to obtain the target linkage parameter; and
a first execution policy generation module, configured to generate a first execution policy based on the target linkage parameter.

In a fifth aspect, the present disclosure provides a computer device, including: a memory and a processor, wherein the memory and the processor are in communicative connection with each other; the memory has computer instructions stored thereon; and the processor executes the computer instructions to perform the method for linkage parameter configuration in the first aspect or any implementation corresponding to the first aspect.

In a sixth aspect, the present disclosure provides a computer-readable storage medium, having computer instructions stored thereon. The computer instructions are used for causing a computer to perform the method for linkage parameter configuration in the first aspect or any implementation corresponding to the first aspect.

According to the method for linkage parameter configuration provided by the embodiments of the present disclosure, the target linkage parameter includes a first linkage parameter that a client expects a target content distribution network (CDN) to execute, and/or a second linkage parameter that the target CDN expects the client to execute. Linkage between a device of the client and the target CDN is achieved through configurations of the first linkage parameter and the second linkage parameter. Since the header information of the hypertext transfer protocol (http) request has no restriction on a length of data carried thereon, a plurality of linkage parameters can be configured according to a need. Namely, both the client and the CDN may perform data communication according to an expectation need of the other party through the configuration of endpoint-cloud linkage parameters, which ensures cooperative linkage between an endpoint and a cloud.

### BRIEF DESCRIPTION OF THE DRAWINGS

To describe the technical solutions in the embodiments of the present disclosure or in the existing technology more clearly, the following will briefly introduce the accompanying drawings required to describe the specific implementations or the existing technology. Apparently, the accompanying drawings in the following description show merely some implementations of the present disclosure, and a person of ordinary skill in the art may still derive other drawings from the accompanying drawings without creative efforts.

FIG. 1 is a flowchart of a method for linkage parameter configuration according to an embodiment of the present disclosure;

FIG. 2 is a flowchart of another method for linkage parameter configuration according to an embodiment of the present disclosure;

FIG. 3 is a flowchart of still another method for linkage parameter configuration according to an embodiment of the present disclosure;

FIG. 4 is a block structural diagram of a linkage parameter configuration apparatus according to an embodiment of the present disclosure;

FIG. 5 is a block structural diagram of another linkage parameter configuration apparatus according to an embodiment of the present disclosure; and

FIG. 6 is a schematic structural diagram of hardware of a computer device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. All other embodiments obtained by a person skilled in the art based on the embodiments of the present disclosure without making creative efforts shall fall within the protection scope of the present disclosure.

In the related technology, the configuration of endpoint-cloud linkage parameters is achieved by carrying endpoint-cloud linkage configuration parameters in the form of query in a requested Uniform/Universal Resource Locator (URL), thereby achieving communication between a client and a CDN end. If the CDN is informed to only distribute audio data to achieve endpoint-cloud communication by carrying a query parameter only_audio=1 in the URL, the URL can be represented as:
http://xx.xxx.com/xxxxx/xxxxonly_audio=1

However, with the increase of the endpoint-cloud linkage parameters, carrying the query parameter in the URL mentioned above may lead to the problem of a long URL. There will be a restriction on the maximum length of the URL. For example, in http 1.1, the maximum length of the URL is limited to 1024 characters, and any excess will be automatically truncated. As a result, the functions corresponding to the truncated endpoint-cloud linkage parameters will fail.

Meanwhile, as the query parameter has a single structure, the various linkage parameters can only be arranged in sequence in the URL. However, some endpoint-cloud linkage parameters may have matching relationships, and this sequential arrangement will break the matching relationships, making it difficult to support configuring a complex function for a linkage parameter. This mode is not easy to expand.

Further, the above mode only covers the one-way linkage where the client informs the CDN to perform an action. Namely, the client carries the query parameter in the URL to inform an action expected to be executed by the CDN, but the CDN cannot inform an action expected to be executed by the client. Namely, the above method cannot support informing the client of a linkage parameter of an action that the CDN expects the client to perform. Namely, the above method only supports one-way linkage, but cannot support two-way linkage.

Based on this, the embodiments of the present disclosure provide a method for linkage parameter configuration, which obtains a target http request by writing a linkage parameter into header information of an http request, and then transmits the target http request to a target CDN to cause the target CDN to generate a first execution policy based on a target linkage parameter. Due to an infinite length of the header information in the http requests, complex data structures may be used to represent linkage parameters in the header information, thereby ensuring the integrity of the matching relationships between the linkage parameters. In addition, in the header information, corresponding linkage parameters can be added as needed to achieve the expandability of linkage parameters.

According to the embodiments of the present disclosure, a method for linkage parameter configuration embodiment is provided. It should be noted that steps shown in the flowchart in the accompanying drawings can be executed in a computer system such as a set of computer-executable instructions. Furthermore, although a logical order is shown in the flowchart. In some cases, the steps shown or described can be executed in an order different from the order here.

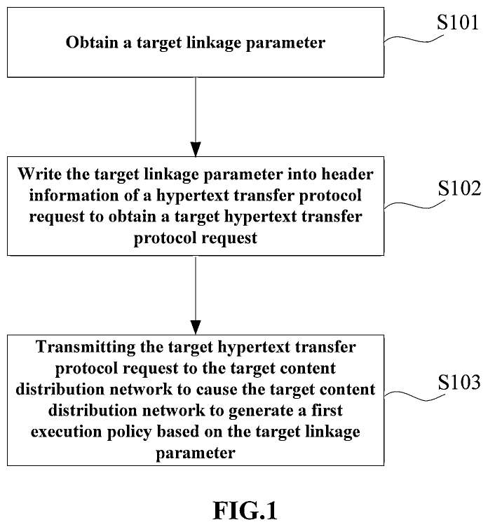

This embodiment provides a method for linkage parameter configuration, which may be applied to the aforementioned client, such as a computer and a mobile terminal. Correspondingly, a local device described in this embodiment is the client. FIG. 1 is a flowchart of a method for linkage parameter configuration according to an embodiment of the present disclosure. As shown in FIG. 1, the flow includes the following steps:

Step S101, obtaining a target linkage parameter.

The target linkage parameter includes a first linkage that a local device expects a target CDN to execute and/or a second linkage parameter that the target CDN expects the local device to execute.

Endpoint-cloud linkage is achieved based on a target application, such as an instant messaging application and a live streaming application. A target application is installed in a client. The target application is in communicative connection to a server of the target application. The server of the target application can be a cloud platform or another presentation form. There are no restrictions on this. The cloud platform is taken as an example. The cloud platform transmits the target linkage parameter to the client. Correspondingly, the client obtains the target linkage parameter.

The target linkage parameter includes the first linkage parameter and/or the second linkage parameter. The first linkage parameter is a linkage parameter that the client expects the target CDN to execute, such as a frame loss function parameter, a recommended packet transmitting rate, and a round-trip delay. The second linkage parameter is a linkage parameter that the target CDN expects the client to execute, such as an acquisition delay and an acquisition packet loss rate. Of course, specific parameters included in the first linkage parameter and the first linkage parameter are set according to an actual need. No restriction is made on this. For example, in scenario A, the target linkage parameter only includes the first linkage parameter. In scenario B, the target linkage parameter only includes the second linkage parameter. In scenario C, the target linkage parameter includes the first linkage parameter and the second linkage parameter.

The target CDN corresponds to the client, namely, a CDN on a communication link of the client. The server of the target application configures the target linkage parameter according to a need and transmits the target linkage parameter to the client. Correspondingly, the client can obtain the second linkage parameter that the target CDN expects the local device to execute. Subsequently, the client writes the target linkage parameter into header information of an http request to obtain a target http request, and transmits the target http request to the target CDN. Namely, the target CDN can obtain the first linkage parameter and the second linkage parameter.

Step S102, writing the target linkage parameter into header information of a hypertext transfer protocol request to obtain a target hypertext transfer protocol request.

The header information of the http requests includes preset header information and the target linkage parameter. The preset header information includes but is not limited to a compression algorithm that can be received by the client, a language type that can be received by the client, and the like. The specific content is set according to an actual need. The target linkage parameter may be represented by a field corresponding to the target linkage parameter, behind the preset header information, to distinguish the preset header information. For example, the preset header information includes field 1 to field 5, and respective corresponding field content. The field corresponding to the target linkage parameter is field A. The field content of taking the target linkage parameter as field A is written behind field A, so that the target linkage parameter is written into the header information of the http request to obtain the target http request.

Step S103, transmitting the target hypertext transfer protocol request to the target content distribution network to cause the target content distribution network to generate a first execution policy based on the target linkage parameter.

After the target http request is obtained, the target http request is sent to the target CDN according to a corresponding protocol specification. Correspondingly, the target CDN may obtain the target linkage parameter in the target http request to generate the first execution policy based on the target linkage parameter.

The first execution policy is applied to a processing policy during subsequent endpoint-cloud communication, such as packet loss processing and frame transmitting rate processing. If there is no target linkage parameter, the target CDN is processed based on its own setting, which may result in low cooperation with the client and a poor communication effect. Through the transmission of the target linkage parameter, the target CDN can obtain the need of the client, thereby adjusting its first execution policy to ensure better endpoint-cloud communication effect.

According to the method for linkage parameter configuration provided by this embodiment, the target linkage parameter includes a first linkage parameter that a client expects a target content distribution network (CDN) to execute, and/or a second linkage parameter that the target CDN expects the client to execute. Linkage between a device of the client and the target CDN is achieved through configurations of the first linkage parameter and the second linkage parameter. Since the header information of the http request has no restriction on a length of data carried thereon, a plurality of linkage parameters may be configured according to a need. Namely, both the client and the CDN may perform data communication according to an expectation need of the other party through the configuration of endpoint-cloud linkage parameters, which ensures cooperative linkage between an endpoint and a cloud.

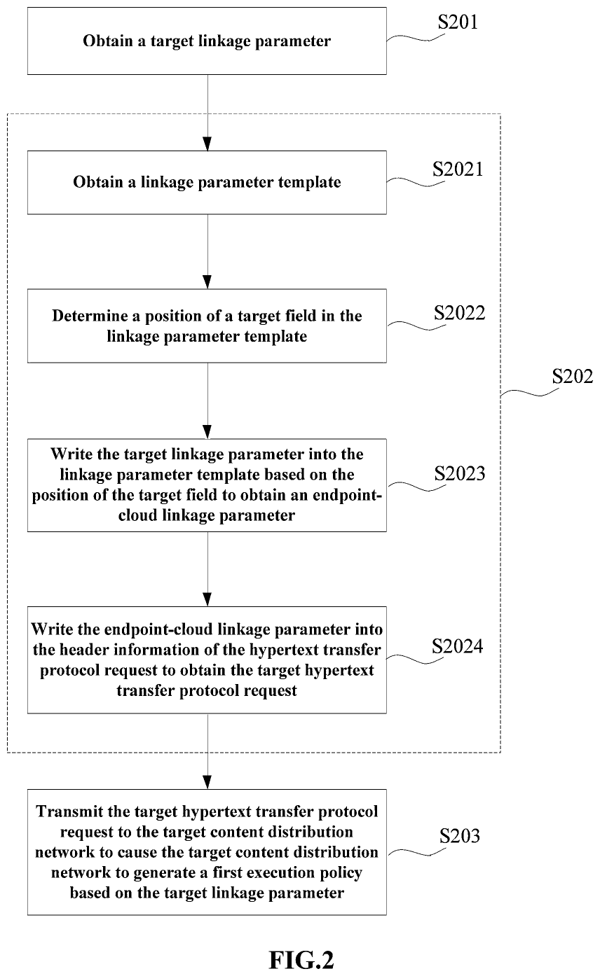

In this embodiment, a method for linkage parameter configuration is provided, which may be applied to the aforementioned client, such as a computer and a mobile terminal. FIG. 2 is a flowchart of a method for linkage parameter configuration according to an embodiment of the present disclosure. As shown in FIG. 2, the flow includes the following steps:

Step S201, obtaining a target linkage parameter.

The target linkage parameter includes a first linkage that a local device expects a target CDN to execute and/or a second linkage parameter that the target CDN expects the local device to execute. For details, refer to step S101 of the embodiment shown in FIG. 1. The details will not be elaborated here.

Step S202, writing the target linkage parameter into header information of a hypertext transfer protocol request to obtain a target hypertext transfer protocol request.

Specifically, step S202 described above includes:

Step S2021, obtaining a linkage parameter template.

The linkage parameter template is used for representing a presentation form of a linkage parameter in the header information.

The linkage parameter template represents a writing position, a writing format, and the like of the target linkage parameter. A writing constraint of the target linkage parameter is reused through the linkage parameter template. There is no need for reediting the target linkage parameter obtained each time, which improves the endpoint-cloud linkage parameter configuration efficiency. An endpoint-cloud linkage parameter is obtained after writing the target linkage parameter into the linkage parameter template.

Step S2022, determining a position of a target field in the linkage parameter template.

The target field corresponds to the target linkage parameter.

The target field represents the position of the target linkage parameter in the linkage parameter template. For recognition of the target field, the target field may be determined after performing character recognition on the target linkage parameter. In addition, since the linkage parameter template is fixed, and the position of the target field in the linkage parameter template is also fixed. Correspondingly, the position of the target field in the linkage parameter can be obtained through one recognition, and the position may be recorded. Subsequently, a recorded result may be directly extracted to obtain the position of the target field.

In some alternative implementations, step S2022 includes:
Step a1, determining a position of a first target field in the linkage parameter template, wherein the first target field corresponds to the first target linkage parameter.
Step a2, determining a position of a second target field in the linkage parameter template, wherein the second target field corresponds to the second target linkage parameter, and the target field includes the first target field and/or the second target field.

As mentioned above, the target linkage parameter includes the first linkage parameter and/or the second linkage parameter. Correspondingly, the corresponding first target field and second target field need to be set in the linkage parameter template. The first target field corresponds to the first linkage parameter, and the second target field corresponds to the second linkage parameter.

The method for determining the positions of the first target field and the second target field is found in the above description for determining the position of the target field, and will not be elaborated here.

If the currently obtained target linkage parameter only includes the first linkage parameter, when the target linkage parameter is written into the linkage parameter template, the field content corresponding to the second target field is empty. Correspondingly, if the currently obtained target linkage parameter only includes the second linkage parameter, when the target linkage parameter is written into the linkage parameter template, the field content of the first target field will be empty.

The first target field and the second target field are used to correspond to the first linkage parameter and the second linkage parameter, respectively, so that it is convenient for the client and the target CDN to parse the field content of the corresponding fields according to their needs. This ensures the accuracy of a correspondence relationship between a linkage parameter and a corresponding object.

Step S2023, writing the target linkage parameter into the linkage parameter template based on the position of the target field to obtain an endpoint-cloud linkage parameter.

After the position of the target field is determined, the target linkage parameter is written as the field content of the target field into the linkage parameter template. The target linkage parameter may be written after a data format of the obtained target linkage parameter is adjusted, or may be directly written without adjusting the data format.

The data format of the target linkage parameter is a data format used when the server of the target application transmits the target linkage parameter to the client, including but not limited to a form of key-value pair or a query parameter, depending on a communication protocol between the server of the target application and the client.

In some alternative implementations, the first linkage parameter includes at least one first function linkage parameter. The first function linkage parameter includes at least one first function linkage sub-parameter and a parameter value of the first function linkage sub-parameter. The second linkage parameter includes at least one second function linkage parameter; and the second function linkage parameter includes at least one second function linkage sub-parameter and a parameter value of the second function linkage sub-parameter.

The first linkage parameter includes at least one first function linkage parameter, and the first function linkage parameter is in one-to-one correspondence to a linkage function. For example, if a desired linkage function includes packet loss and a packet transmitting rate, the first function linkage parameter corresponds to two first function linkage parameters. Namely, the first function linkage parameter 1 corresponds to the packet loss, and the second function linkage parameter 2 corresponds to the packet transmitting rate.

Further, the first function linkage parameter includes at least one first function linkage sub-parameter and the parameter value of the first function linkage sub-parameter. For example, the linkage function is the package transmitting rate, namely, the second function linkage parameter 2 mentioned above. The second function linkage parameter includes the first function linkage sub-parameters corresponding to three parameters: an initial packet transmitting rate, a round-trip delay, and a packet loss rate. Namely, the first function linkage sub-parameter 2a corresponds to the initial packet transmitting rate; the first function linkage sub-parameter 2b corresponds to the round-trip delay; and the first function linkage sub-parameter 2c corresponds to the packet loss rate. Each first function linkage sub-parameter has a corresponding parameter value, namely, the parameter value of the first function linkage sub-parameter.

The form of the second function linkage parameter is similar to that of the first function linkage parameter. The form can be found in the description of the first function linkage parameter in the previous text and will not be elaborated here.

For example, the first target field is ClientStrategyPS, namely, a client policy field used for representing a parameter identifier corresponding to the first linkage parameter. The second target field is VendorStrategyPS, namely, a cloud policy field used for representing a parameter identifier corresponding to the second linkage parameter.

The first linkage parameter includes two first function linkage parameters, namely a frame loss function parameter configuration DropFrameParam and a packet transmitting rate recommendation function RecommendInitialNetworkParam. The first function linkage parameter DropFrameParam includes four first function linkage sub-parameters: an initial packet transmitting rate Bandwidth, a round-trip delay RTT, a packet loss rate PacketLossRate, and a maximum packet length BestMTULength. The four first function linkage sub-parameters have respective parameter values, namely, the initial packet transmitting rate Bandwidth=4000 kb/s, the round-trip delay RTT=23 ms, the packet loss rate PacketLossRate=0.1, and the maximum packet length BestMTULength=1000 Byte.

Of course, the linkage parameter can be further expanded according to an actual need.

The first linkage parameter includes at least one first function linkage parameter, and the first function linkage parameter includes at least one first function linkage sub-parameter. Their specific quantities are not limited, thus achieving flexible expansion of linkage parameters without secondary development on endpoints.

In some alternative implementations, if the first function linkage parameter includes a plurality of first function linkage sub-parameters, the respective first function linkage sub-parameters and the parameter values of the first function linkage sub-parameters are represented in a form of key-value pairs; the key-value pairs corresponding to all the first function linkage sub-parameters are combined using a preset identifier; and content after the combination is a parameter value of the first function linkage parameter.

The first linkage parameter may include a plurality of levels of parameters. For example, the levels of the first linkage parameter, the first function linkage parameter, and the first function linkage sub-parameter are ranked from top to bottom. Of course, it is not limited that the first function linkage sub-parameter is the last level of the first linkage parameter. A depth of specific levels is set according to an actual need. No restriction is made on this.

If the first function linkage sub-parameter is the last level, the first function linkage sub-parameter and its corresponding parameter value are represented in the form of a key-value pair. Namely, the first function linkage sub-parameter is key, and the parameter value of the first function linkage sub-parameter is value. They are represented in the form of key: value.

If the first function linkage parameter includes a plurality of first function linkage sub-parameters, the first function linkage sub-parameters are combined using a preset identifier, such as a paired brace “{ }”.

Specifically, the representation forms of the first linkage parameter and the second linkage parameter may be in a query format or a json character string format. Of course, other formats can be used. No restriction is made on this.

The first linkage parameter is represented using a key-value pair and a preset identifier. This representation mode is similar to a representation mode of a parameter in a url. A parse mode does not need to be developed, and the endpoint-cloud linkage parameter configuration efficiency is improved.

Step S2024, the endpoint-cloud linkage parameter is written into the header information of the hypertext transfer protocol request to obtain the target hypertext transfer protocol request.

After the above steps, the endpoint-cloud linkage parameter obtained by using the linkage parameter template is written into the header information of the http request to obtain the target http request.

In some alternative implementations, step S2024 described above includes:
Step b1, preset header information of the hypertext transfer protocol request is obtained.
Step b2, the target hypertext transfer protocol request is obtained based on the preset header information and the endpoint-cloud linkage parameter.

For example, in an example of the header information, the preset header information is the first five fields and their field content. The specific content of the preset header information is related to an actual communication scenario. No restriction is made on its specific fields and field content of the fields. The preset header information is combined with the endpoint-cloud linkage parameter to obtain the target http request.

The first linkage parameter and the second linkage parameter in the endpoint-cloud linkage parameters are represented in the form of key-value pairs. The first linkage parameter corresponds to the first target field is ClientStrategyPS, and the second linkage parameter corresponding to the second target field is VendorStrategyPS.

Step S203, the target hypertext transfer protocol request is sent to the target content distribution network to cause the target content distribution network to generate a first execution policy based on the target linkage parameter. For details, refer to the description of step S103 of the embodiment shown in FIG. 1. The details will not be elaborated here.

According to the method for linkage parameter configuration provided in this embodiment, through the setting of the linkage parameter template, after the target linkage parameter is obtained, only the position of the target field needs to be queried and the target linkage parameter needs to be written. There is no need to organize the target linkage parameter to meet a corresponding protocol transmission requirement, which improves the endpoint-cloud linkage parameter configuration efficiency.

In some alternative implementations, the above method for linkage parameter configuration includes:
Step c1, the target linkage parameter is analyzed to obtain the second linkage parameter.
Step c2, a second execution policy is generated based on the second linkage parameter.

As mentioned earlier, the target linkage parameter is sent by the server of the target application to the client. After obtaining the target linkage parameter, the client parsesthe target linkage parameter to obtain the second linkage parameter. The second linkage parameter is a parameter that the target CDN expects the client to execute. After the second linkage parameter is obtained, the second execution policy is generated based on this.

In some alternative implementations, the generation of the second execution policy further includes obtaining of a current network state, and the second execution policy is generated in conjunction with the current network state and the second linkage parameter. Namely, the second execution policy is generated according to a current state of the client and a demand of the target CDN for the client. The second execution policy is a policy that needs to be executed when the client communicates with the target CDN.

The client generates a local second execution policy based on the second linkage parameter, so that the execution policy is determined based on the demand of the target CDN.

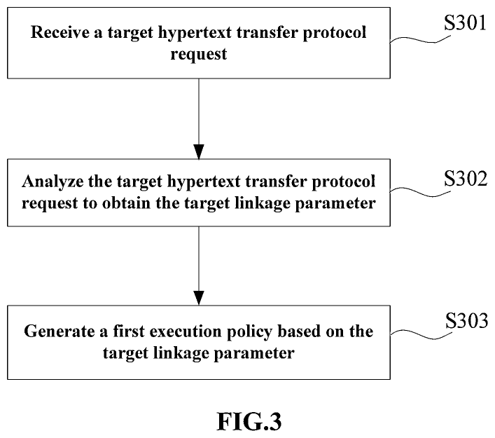

In this embodiment, a method for linkage parameter configuration is provided, which may be applied to the aforementioned target CDN. FIG. 3 is a flowchart of a method for linkage parameter configuration according to an embodiment of the present disclosure. As shown in FIG. 3, the flow includes the following steps:

Step S301, receiving a target hypertext transfer protocol request.

Header information of the target http request includes a target linkage parameter, and the target linkage parameter includes a first linkage parameter that a client expects a local device to execute and/or a second linkage parameter that the local device expects the client to execute.

Specific content of the target http request is found in the descriptions of the corresponding parts in the embodiment of FIG. 1 or FIG. 2, and will not be elaborated here.

Step S302, the target hypertext transfer protocol request is parsed to obtain the target linkage parameter.

The parse mode for the target http request is related to a data format represented by an endpoint-cloud linkage parameter in a linkage parameter template. No restriction is made on the specific parse mode. After the target http request is parsed, the target linkage parameter is obtained. Step S303, generating a first execution policy based on the target linkage parameter.

The target linkage parameter includes a first linkage parameter and/or a second linkage parameter. When the first execution policy is generated, the first linkage parameter is main, and the second linkage parameter is auxiliary. Namely, the generation of the first execution policy is mainly based on the first linkage parameter, and the second linkage parameter is auxiliary.

In some alternative implementations, step S303 includes:
Step d1, a current communication state of the local device is obtained.
Step d2, the first execution policy is generated based on the current communication state and the target linkage parameter.

The current communication state includes but is not limited to a current network state, a current packet loss rate, and the like. The first execution policy is generated according to the current communication state and the target linkage parameter. The first execution policy is generated according to the current communication state of the local device, which ensures that the first execution policy may meet the need of the client and adapt to the communication state of the local device, thereby achieving a good endpoint-cloud linkage effect.

According to the method for linkage parameter configuration provided by this embodiment, the target linkage parameter includes a first linkage parameter that a client expects a target content distribution network (CDN) to execute, and/or a second linkage parameter that the target CDN expects the client to execute. Linkage between a device of the client and the target CDN is achieved through configurations of the first linkage parameter and the second linkage parameter. Since the header information of the http request has no restriction on a length of data carried thereon, a plurality of linkage parameters can be configured according to a need. Namely, both the client and the CDN can perform data communication according to an expectation need of the other party through the configuration of endpoint-cloud linkage parameters, which ensures cooperative linkage between an endpoint and a cloud.

As a specific application embodiment of the embodiments of the present disclosure, the server of the target application is a cloud platform. A user sets a target configuration parameter through interaction with the cloud platform. The cloud platform transmits the target configuration parameter to the client of the target application. After the target application is started at the client, the client can obtain the target configuration parameter. The target configuration parameter includes a first linkage parameter and a second linkage parameter. The client generates a target http request based on a linkage parameter template and the target configuration parameter. After the target http request is sent to the target CDN, the target CDN correspondingly receives the target http request and parses it to obtain the target configuration parameter. The target CDN generates a first execution policy based on the target configuration parameter, and the client generates a second execution policy based on the second linkage parameter. Based on this, when the client communicates with the target CDN, the client processes data based on the second execution policy, and the target CDN processes data based on the first execution policy.

This embodiment further provides a linkage parameter configuration apparatus. The apparatus is configured to implement the above embodiments and preferred implementations. Those contents that have been described will not be elaborated. As used below, the term “module” may be a combination of software and/or hardware that implements a predetermined function. Although the apparatus described in the following embodiments is preferably implemented in software, the implementation of hardware or a combination of software and hardware is also possible and envisioned.

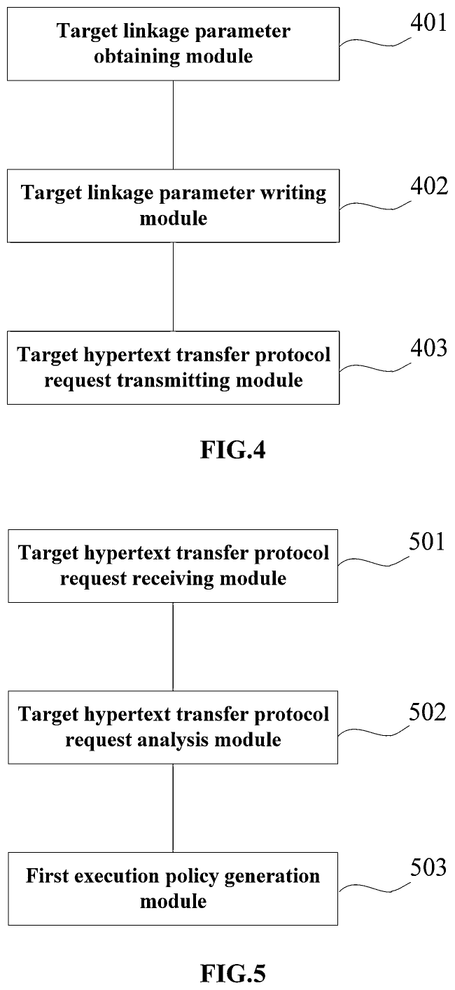

The linkage parameter configuration apparatus provided in this embodiment, as shown in FIG. 4, includes:
a target linkage parameter obtaining module 401, configured to obtain a target linkage parameter, wherein the target linkage parameter includes a first linkage parameter that a local device expects a target content distribution network to execute and/or a second linkage parameter that the target content distribution network expects the local device to execute;
a target linkage parameter writing module 402, configured to write the target linkage parameter into header information of a hypertext transfer protocol request to obtain a target hypertext transfer protocol request; and
a target hypertext transfer protocol request transmitting module 403, configured to transmit the target hypertext transfer protocol request to the target content distribution network to cause the target content distribution network to generate a first execution policy based on the target linkage parameter.

In some alternative implementations, the target linkage parameter writing module 402 includes:
a linkage parameter template obtaining unit, configured to obtain a linkage parameter template, wherein the linkage parameter template is used for representing a presentation form of a linkage parameter in the header information;
a position determining unit for target field, configured to determine a position of a target field in the linkage parameter template, wherein the target field corresponds to the target linkage parameter;
a target linkage parameter writing unit, configured to write the target linkage parameter into the linkage parameter template based on the position of the target field to obtain an endpoint-cloud linkage parameter; and
an endpoint-cloud linkage parameter writing unit, configured to write the endpoint-cloud linkage parameter into the header information of the hypertext transfer protocol request to obtain the target hypertext transfer protocol request.

In some alternative implementations, the target field position determining unit includes:
a position determining subunit for first target field, configured to determine a position of a first target field in the linkage parameter template, wherein the first target field corresponds to the first target linkage parameter; and/or,
a position determining subunit for second target field, configured to determine a position of a second target field in the linkage parameter template, wherein the second target field corresponds to the second target linkage parameter, and the target field includes the first target field and/or the second target field.

In some alternative implementation, the first linkage parameter includes at least one first function linkage parameter; the first function linkage parameter includes at least one first function linkage sub-parameter and a parameter value of the first function linkage sub-parameter; and/or, the second linkage parameter includes at least one second function linkage parameter; and the second function linkage parameter includes at least one second function linkage sub-parameter and a parameter value of the second function linkage sub-parameter.

In some alternative implementations, if the first function linkage parameter includes a plurality of first function linkage sub-parameters, the respective first function linkage sub-parameters and the parameter values of the first function linkage sub-parameters are represented in a form of key-value pairs; the key-value pairs corresponding to all the first function linkage sub-parameters are combined using a preset identifier; and content after the combination is a parameter value of the first function linkage parameter.

In some alternative implementations, the endpoint-cloud linkage parameter writing unit includes:
a preset header information obtaining subunit, configured to obtain preset header information of the hypertext transfer protocol request; and
a target hypertext transfer protocol request obtaining subunit, configured to obtain the target hypertext transfer protocol request based on the preset header information and the endpoint-cloud linkage parameter.

In some alternative implementations, the apparatus further includes:
a parse module, configured to parse the target linkage parameter to obtain the second linkage parameter; and
a second execution policy generation module, configured to generate a second execution policy based on the second linkage parameter.

The linkage parameter configuration apparatus provided in this embodiment, as shown in FIG. 5, includes:
a target hypertext transfer protocol request receiving module 501, configured to receive a target hypertext transfer protocol request, wherein header information of the target hypertext transfer protocol request includes a target linkage parameter, and the target linkage parameter includes a first linkage parameter that a client expects a local device to execute and/or a second linkage parameter that the local device expects the client to execute;
a target hypertext transfer protocol request parse module 502, configured to parse the target hypertext transfer protocol request to obtain the target linkage parameter; and
a first execution policy generation module 503, configured to generate a first execution policy based on the target linkage parameter.

In some alternative implementations, the first execution policy generation module 503 includes:
a current communication state obtaining unit, configured to obtain a current communication state of the local device; and
a first execution policy generation unit, configured to generate the first execution policy based on the current communication state and the target linkage parameter.

The linkage parameter configuration apparatus in this embodiment is presented in the form of functional units. The units here are Application Specific Integrated Circuit (ASICs), processors and memories that execute one or more software or fixed programs, and/or other devices that can provide the above functions.

The further function descriptions of the above modules and units are the same as the corresponding embodiments mentioned above, and will not be elaborated here.

The embodiments of the present disclosure further provide a computer device with the linkage parameter configuration device shown in FIG. 4 or FIG. 5.

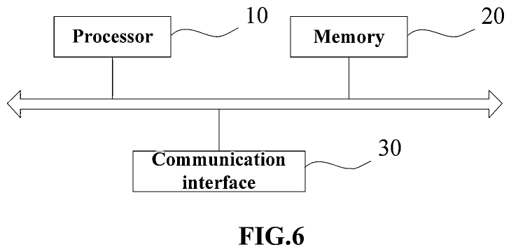

Referring to FIG. 6, FIG. 6 is a schematic structural diagram of a computer device provided in an embodiment of the present disclosure. As shown in FIG. 6, the computer device includes: one or more processors 10, a memory 20, and interfaces for connecting the respective components, including a high-speed interface and a low-speed interface. The respective components are in communicative connection to each other using different buses, and can be mounted on a common motherboard or in other ways as needed. The processor can process instructions executed in the computer device, including instructions stored in or on the memory to display graphical information of a Graphical User Interface (GUI) on an external input/output apparatus (such as a display device coupled to an interface). In some alternative implementations, if necessary, a plurality of processors and/or a plurality of buses can be used together with a plurality of memories and a plurality of memories. Similarly, a plurality of computer devices can be connected. The respective devices provide some necessary operations (such as serving as a server array, a group of blade servers, or a multiprocessor system). In FIG. 6, one processor 10 is taken as an example.

The processor 10 can be a central processing unit, a network processor, or a combination thereof. The processor 10 can further include a hardware chip. The above hardware chip can be an ASIC, a programmable logic device, or a combination thereof. The above-mentioned programmable logic device can be a complex programmable logic device, a field programmable logic gate array, a general-purpose array logic, or any combination thereof.

The memory 20 stores instructions that can be executed by at least one processor 10 to cause the at least one processor 10 to implement the method illustrated in the above embodiment.

The memory 20 may include a program storage region and a data storage region. The program storage region may store an operating system and an application program required by at least one function. The data storage region may store data created according to use of the computer device. In addition, the memory 20 may include a high-speed random access memory and may further include a non-transient memory, such as at least one disk storage device, a flash memory device, or other non-transient solid-state storage devices. In some alternative implementations, the memory 20 includes a memory remotely located with respect to the processor 10. These remote memories can be connected to the computer device through a network. Examples of the above network include, but are not limited to, Internets, intranets, local area networks, mobile communication networks, and combinations thereof.

The memory 20 may include a volatile memory, such as a random access memory. Or, the memory may include a non-volatile memory, such as a flash memory, a hard disk drive, or a solid-state disk drive. The memory 20 can further include a combination of the aforementioned types of memories.

The computer device further includes a communication interface 30, used for communicating the computer device with other devices or communication networks.

The embodiments of the present disclosure further provide a computer-readable storage medium. The above method according to the embodiments of the present disclosure can be implemented in hardware or firmware, or can be implemented as being recordable on a storage medium, or implemented as a computer code that is downloaded through a network, originally stored on a remote storage medium or a non-transient machine-readable storage medium, and to be stored on a local storage medium. Therefore, the method described here can be processed by software stored on a storage medium using a general-purpose computer, a dedicated processor, or programmable or dedicated hardware. The storage medium can be a magnetic disk, a compact disc, a read-only memory, a random access memory, a flash memory, a hard disk drive, a solid-state hard disk drive, or the like. Further, the storage medium may further include a combination of the aforementioned types of memories. It can be understood that a computer, processor, microprocessor controller, or programmable hardware includes a storage component that can store or receive software or a computer code. When the software or computer code is accessed and executed by the computer, processor, or hardware, the method illustrated above is implemented.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is transmitted to the user to clearly remind the user that personal information of the user needs to be involved in an operation requested to be executed. Thus, the user may independently select whether to provide the personal information to software or hardware such as an electronic device, an application program, a server, or a storage medium that performs the operation of the technical solutions of the present disclosure according to the prompt information.

As an alternative but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

Although the embodiments of the present disclosure are described in conjunction with the accompanying drawings, those skilled in the art may make various modifications and transformations without departing from the spirit and scope of the present disclosure. These modifications and transformations shall fall within the scope defined by the attached claims.

What is claimed is:

1. A method for linkage parameter configuration, comprising:
obtaining a target linkage parameter, wherein the target linkage parameter comprises a first linkage parameter that a local device expects a target content distribution network to execute and/or a second linkage parameter that the target content distribution network expects the local device to execute;
writing the target linkage parameter into header information of a hypertext transfer protocol request to obtain a target hypertext transfer protocol request; and
transmitting the target hypertext transfer protocol request to the target content distribution network to cause the target content distribution network to generate a first execution policy based on the target linkage parameter.

2. The method of claim 1, wherein writing the target linkage parameter into header information of a hypertext transfer protocol request to obtain a target hypertext transfer protocol request comprises:
obtaining a linkage parameter template, wherein the linkage parameter template is configured to represent a presentation form of a linkage parameter in the header information;
determining a position of a target field in the linkage parameter template, wherein the target field corresponds to the target linkage parameter;
writing the target linkage parameter into the linkage parameter template based on the position of the target field to obtain an endpoint-cloud linkage parameter; and
writing the endpoint-cloud linkage parameter into the header information of the hypertext transfer protocol request to obtain the target hypertext transfer protocol request.

3. The method of claim 2, wherein determining a position of a target field in the linkage parameter template comprises:
determining a position of a first target field in the linkage parameter template, wherein the first target field corresponds to the first linkage parameter; and/or
determining a position of a second target field in the linkage parameter template, wherein the second target field corresponds to the second linkage parameter, and the target field comprises the first target field and/or the second target field.

4. The method of claim 1, wherein the first linkage parameter comprises at least one first function linkage parameter, the first function linkage parameter comprises at least one first function linkage sub-parameter and a parameter value of the first function linkage sub-parameter, and/or the second linkage parameter comprises at least one second function linkage parameter, the second function linkage parameter comprises at least one second function linkage sub-parameter and a parameter value of the second function linkage sub-parameter.

5. The method of claim 4, wherein in response to the first function linkage parameter comprising a plurality of first function linkage sub-parameters, the respective first function linkage sub-parameters and the parameter values of the first function linkage sub-parameters are represented in a form of key-value pairs, the key-value pairs corresponding to all the first function linkage sub-parameters are combined using a preset identifier, and the combined content is a parameter value of the first function linkage parameter.

6. The method of claim 2, wherein writing the endpoint-cloud linkage parameter into the header information of the hypertext transfer protocol request to obtain the target hypertext transfer protocol request comprises:
obtaining preset header information of the hypertext transfer protocol request; and
obtaining the target hypertext transfer protocol request based on the preset header information and the endpoint-cloud linkage parameter.

7. The method of claim 1, wherein the method further comprises:
parsing the target linkage parameter to obtain the second linkage parameter; and
generating a second execution policy based on the second linkage parameter.

8. A method for linkage parameter configuration, wherein the method comprises:
receiving a target hypertext transfer protocol request, wherein header information of the target hypertext transfer protocol request comprises a target linkage parameter, and the target linkage parameter comprises a first linkage parameter that a client expects a local device to execute and/or a second linkage parameter that the local device expects the client to execute;
parsing the target hypertext transfer protocol request to obtain the target linkage parameter; and
generating a first execution policy based on the target linkage parameter.

9. The method of claim 8, wherein generating a first execution policy based on the target linkage parameter comprises:
obtaining a current communication state of the local device; and
generating the first execution policy based on the current communication state and the target linkage parameter.

10. A computer device, comprising:
a memory and a processor, wherein the memory and the processor are in communicative connection with each other; the memory has computer instructions stored thereon; and the processor executes the computer instructions to:
obtain a target linkage parameter, wherein the target linkage parameter comprises a first linkage parameter that a local device expects a target content distribution network to execute and/or a second linkage parameter that the target content distribution network expects the local device to execute;
write the target linkage parameter into header information of a hypertext transfer protocol request to obtain a target hypertext transfer protocol request; and
transmit the target hypertext transfer protocol request to the target content distribution network to cause the target content distribution network to generate a first execution policy based on the target linkage parameter.

11. The computer device of claim 10, wherein the computer device is further caused to write the target linkage parameter into header information of a hypertext transfer protocol request to obtain a target hypertext transfer protocol request by:
obtaining a linkage parameter template, wherein the linkage parameter template is configured to represent a presentation form of a linkage parameter in the header information; and
determining a position of a target field in the linkage parameter template, wherein the target field corresponds to the target linkage parameter.

12. The computer device of claim 11, wherein the computer device is further caused to write the target linkage parameter into header information of a hypertext transfer protocol request to obtain a target hypertext transfer protocol request by:
writing the target linkage parameter into the linkage parameter template based on the position of the target field to obtain an endpoint-cloud linkage parameter; and
writing the endpoint-cloud linkage parameter into the header information of the hypertext transfer protocol request to obtain the target hypertext transfer protocol request.

13. The computer device of claim 12, wherein the computer device is further caused to write the endpoint-cloud linkage parameter into the header information of the hypertext transfer protocol request to obtain the target hypertext transfer protocol request by:
obtaining preset header information of the hypertext transfer protocol request; and
obtaining the target hypertext transfer protocol request based on the preset header information and the endpoint-cloud linkage parameter.

14. The computer device of claim 11, wherein the computer device is further caused to determine a position of a target field in the linkage parameter template by:
determining a position of a first target field in the linkage parameter template, wherein the first target field corresponds to the first linkage parameter.

15. The computer device of claim 14, wherein the computer device is further caused to determine a position of a target field in the linkage parameter template by:
determining a position of a second target field in the linkage parameter template, wherein the second target field corresponds to the second linkage parameter, and the target field comprises the first target field and/or the second target field.

16. The computer device of claim 10, wherein the first linkage parameter comprises at least one first function linkage parameter, the first function linkage parameter comprises at least one first function linkage sub-parameter and a parameter value of the first function linkage sub-parameter.

17. The computer device of claim 16, wherein the second linkage parameter comprises at least one second function linkage parameter, the second function linkage parameter comprises at least one second function linkage sub-parameter and a parameter value of the second function linkage sub-parameter.

18. The computer device of claim 16, wherein in response to the first function linkage parameter comprising a plurality of first function linkage sub-parameters, the respective first function linkage sub-parameters and the parameter values of the first function linkage sub-parameters are represented in a form of key-value pairs.

19. The computer device of claim 18, wherein the key-value pairs corresponding to all the first function linkage sub-parameters are combined using a preset identifier, and the combined content is a parameter value of the first function linkage parameter.

20. The computer device of claim 10, wherein the computer device is further caused to:
parse the target linkage parameter to obtain the second linkage parameter; and
generate a second execution policy based on the second linkage parameter.
